(19) United States
(12) Patent Application Publication
(10) Pub. No.: US 2024/0177003 A1
(43) Pub. Date: May 30, 2024

(54) VEHICLE REPOSITIONING DETERMINATION FOR VEHICLE POOL

(71) Applicant: The Regents of the University of Michigan, Ann Arbor, MI (US)

(72) Inventors: Lei YING, Ann Arbor, MI (US); Honghao WEI, Ann Arbor, MI (US); Zixian YANG, Ann Arbor, MI (US)

(21) Appl. No.: 18/507,042

(22) Filed: Nov. 11, 2023

Related U.S. Application Data
(60) Provisional application No. 63/424,724, filed on Nov. 11, 2022.

(51) Int. Cl. G06N 3/08; G06N 3/0464

(52) U.S. Cl. CPC G06N 3/08; G06N 3/0464

(57) ABSTRACT

A system and method for determining vehicle repositioning data for a vehicle pool. The system is configured to perform the method, and the method includes: training a value function using historical ride sharing data; obtaining estimated passenger arrival data, wherein the estimated passenger arrival data is obtained by generating the estimated passenger arrival data using a temporal memory convolutional neural network (TM-CNN); determining a vehicle repositioning policy based on the trained value function and the estimated passenger arrival data; and determining vehicle repositioning data for a vehicle pool based on the vehicle repositioning policy.

### TECHNICAL FIELD

This invention relates to repositioning, or at least determining repositioning information for, a pool of vehicles, such as a pool of passenger automobiles.

### BACKGROUND

Vehicle repositioning information for a vehicle pool, such as a ride hailing or sharing vehicle pool having a plurality of vehicles, is used to indicate where vehicles should be repositioned during times when vehicles are not being used. For example, ride hailing services may be offered by a ride hailing system that includes a ride hailing vehicle pool having a plurality of passenger vehicles, where each passenger vehicle is usable to offer a ride to a customer for purposes of transporting the customer from a start location to an end location. Such ride hailing services are offered by DiDi™, Lyft™, and Uber™.

Supply and demand of available vehicles and customers fluctuates over time and so there are often instances when vehicles are “empty,” which means the vehicle is without a customer. These empty vehicles are considered to be in an idle state when waiting for a customer. Conventional systems attempt to determine repositioning policies so as to determine repositioning data indicating where vehicles should move during this idle state when empty.

### SUMMARY

In accordance with an aspect of the invention, there is provided a method of determining vehicle repositioning data for a vehicle pool. The method includes: training a value function using historical ride sharing data; obtaining estimated passenger arrival data, wherein the estimated passenger arrival data is obtained by generating the estimated passenger arrival data using a temporal memory convolutional neural network (TM-CNN); determining a vehicle repositioning policy based on the trained value function and the estimated passenger arrival data; and determining vehicle repositioning data for a vehicle pool based on the vehicle repositioning policy.

According to various embodiments, this method may further include any one of the following features or any technically-feasible combination of some or all of these features:
the historical ride sharing data includes trajectory data from the vehicle pool;
the TM-CNN includes temporal memory (TM) and a convolutional neural network, and wherein the TM includes at least one of long short-term memory and a gated recurrent unit (GRU);
the CNN includes an encoding layer and a decoding layer, and wherein the TM is interposed in an embedding layer between the encoding layer and the decoding layer;
input into the TM-CNN includes two-dimensional (2D) passenger arrival data representing passenger arrival information for locations within two-dimensional space and for a given time or time period;
the vehicle repositioning policy is determined periodically according to a predetermined time interval;
the vehicle repositioning data is for a plurality of vehicles of the vehicle pool;
the vehicle repositioning policy is determined using an optimization lookahead method that takes into consideration the estimated passenger arrival data;
the optimization lookahead method uses linear programming (LP); and/or
a controllable fraction is determined based on the historical ride sharing data or other historical ride sharing data, and wherein the controllable fraction is used for determining the vehicle repositioning policy.

In accordance with another aspect of the invention, there is provided a vehicle repositioning system. The vehicle repositioning system includes: at least one processor; and memory storing computer instructions. The vehicle repositioning system is configured to use the at least one processor to execute the computer instructions so that when the computer instructions are executed by the at least one processor, the vehicle repositioning system: trains a value function using historical ride sharing data; obtains estimated passenger arrival data, wherein the estimated passenger arrival data is obtained by generating the estimated passenger arrival data using a temporal memory convolutional neural network (TM-CNN); determines a vehicle repositioning policy based on the trained value function and the estimated passenger arrival data; and determines vehicle repositioning data for a vehicle pool based on the vehicle repositioning policy.

According to various embodiments, this vehicle repositioning system may further include any one of the following features or any technically-feasible combination of some or all of these features:
the historical ride sharing data includes trajectory data from the vehicle pool;
the TM-CNN includes temporal memory (TM) and a convolutional neural network, and wherein the TM includes at least one of long short-term memory and a gated recurrent unit (GRU);
the CNN includes an encoding layer and a decoding layer, and wherein the TM is interposed in an embedding layer between the encoding layer and the decoding layer;
input into the TM-CNN includes two-dimensional (2D) passenger arrival data representing passenger arrival information for locations within two-dimensional space and for a given time or time period;
the vehicle repositioning policy is determined periodically according to a predetermined time interval;
the vehicle repositioning data is for a plurality of vehicles of the vehicle pool;
the vehicle repositioning policy is determined using an optimization lookahead method that takes into consideration the estimated passenger arrival data;
the optimization lookahead method uses linear programming (LP); and/or
a controllable fraction is determined based on the historical ride sharing data or other historical ride sharing data, and wherein the controllable fraction is used for determining the vehicle repositioning policy.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications or operating system that includes vehicle repositioning data system, a ride sharing data computer system, and a vehicle pool, according to one embodiment; and

FIG. 2 is a flowchart of a process for determining vehicle repositioning data, according to one embodiment;

FIG. 3 is a diagrammatic representation of a spatial grid or map having a set of regions to which vehicle repositioning data pertains, according to one embodiment;

FIG. 4 is a diagrammatic representation of a long short-term memory convolutional neural network (LSTM-CNN), according to one embodiment;

FIG. 5 is a flowchart illustrating a method of determining vehicle repositioning data for a vehicle pool, according to one embodiment;

FIGS. 6 and 7 show a spatial grid without (FIG. 6) and with (FIG. 7) vehicle repositioning data disposed thereover, according to one embodiment;

FIG. 8 is a graph illustrating completion rates when varying the controllable fractions, and illustrates that the disclosed algorithm outperforms the other policies under different controllable fractions, according to one embodiment;

FIG. 9 is a graph illustrating spatial variance against completion rates, which shows that as the spatial heterogeneity increases, the completion rate decreases for all algorithms with different speed, according to one embodiment;

FIG. 10 is a graph illustrating a number of vehicles against completion rates, which shows the influence of the total number of vehicles on the performance, according to one embodiment;

FIGS. 11A-B are graphs showing the completion rate (FIG. 11A) and travel (fuel) cost (FIG. 11B) with the completion rate among different objective functions, according to one embodiment;

FIG. 12 is a spatial graph with a heat map (left) and grouped main areas of a city (right), according to one embodiment; and

FIG. 13 is a graph showing the disclosed method performance against other algorithms, according to one embodiment.

### DETAILED DESCRIPTION

The system and method described herein enables determining vehicle repositioning data based on a vehicle repositioning policy that is determined by an optimization process that considers a controllable fraction and non-stationarity of the system, at least according to embodiments. The vehicle repositioning data system includes at least one processor and memory storing computer instructions that, when executed by the at least one processor, cause the system to perform a method for determining vehicle repositioning data (or a vehicle repositioning policy) for a pool of vehicles, such as a ride sharing or hailing vehicle pool (collectively, “ride sharing vehicle pool”) having a plurality of vehicles participating in a ride sharing environment, such as those offered by DiDi™, Lyft™, and Uber™. The vehicle repositioning data for a vehicle pool is data indicating a repositioning location for at least one vehicle of the vehicle pool. In embodiments, the vehicle repositioning data is determined based on a vehicle repositioning policy that is determined through formulating the ride sharing system as a vehicle repositioning problem that is solved using an optimization technique. For example, in one embodiment, the vehicle repositioning problem is formulated as a multi-step lookahead optimization problem, which, according to embodiments, uses linear programming (LP) to maximize order completion rate of the ride sharing system.

According to embodiments, the method includes determining a controllable fraction for a vehicle pool and determining a vehicle repositioning policy for the vehicle pool based on the controllable fraction for the vehicle pool. As used herein, “controllable fraction” refers to a percentage or fraction of drivers that follow repositioning recommendations, and this value may be estimated or determined based on historical data. According to implementations, this allows consideration of the real-world observation that not all drivers will accept repositioning recommendations. Furthermore, the controllable fraction may be used as a part of formulating an optimization problem, such as a linear programming (LP) problem, used to determine the vehicle repositioning policy.

According to embodiments, the vehicle repositioning policy takes into consideration the non-stationarity of the vehicles, particularly, by formulating a vehicle repositioning problem as a T-step lookahead optimization problem that seeks to maximize order completion rate. As used herein, “order completion rate” is a value indicating a number or proportion of orders (e.g., ride hailing or sharing orders) completed by drivers relative to a number of total orders. In embodiments, LP is used to determine the vehicle repositioning policy and, in particular, LP with a lookahead time horizon T, which explicitly models the non-stationarity of the ride sharing system, such as vehicle positions within the lookahead or future time horizon T. At least in some embodiments, the vehicle repositioning policy is defined according to an objective function or maximization function (collectively, “objective function”).

According to embodiments, pretrained data is generated using a machine learning (ML) training process and is used for determining the vehicle repositioning policy. In at least some embodiments, the pretrained data is data representing a pretrained value function that is incorporated into the objective function of the vehicle repositioning policy. According to embodiments, incorporating the pretrained value function into the objective function at each time not only optimizes the completion rate (or order completion rate) over T time slots, but also captures the future rewards of the system. In embodiments, the ML training process is a reinforcement learning (RL) process that uses RL to generate the pretrained value function based on using historical data, such as trajectory data (e.g., global navigation satellite system (GNSS) data) from vehicles, as input.

According to embodiments, estimated passenger arrival data is generated using a neural network (NN) and, in some embodiments, a convolutional NN (CNN), where historical passenger arrival data is used as input into the CNN. In embodiments, the input includes passenger arrival data that is specified for two dimensions (e.g., using latitude and longitude) and for a given time—this is referred to as a two dimensional (2D) passenger arrival data. Further, in at least one embodiment, temporal memory (TM) is used in conjunction with the CNN to provide a TM-CNN that includes the CNN and the TM, and the TM-CNN is configured to generate the estimated passenger arrival data, which captures spatiotemporal correlations of predicted passenger arrival rates. Furthermore, according to implementations employing such an embodiment using the TM-CNN, this spatiotemporal prediction of passenger arrival rates works well with LP.

According to embodiments, a splitting technique is used to enable consideration of cross-region vehicle rider orders. The splitting technique may be used to take into consideration of the fact that drivers may accept orders/passengers/customers from other adjacent regions. Many existing approaches for vehicle repositioning in largescale ride-hailing platforms

either do not consider the spatiotemporal mismatch between supply and demand in real-time or do not consider the long-term balance from the system perspective.

The past decade has seen rapid proliferation of ride sharing services. Large-scale ride-hailing systems, such as Uber™, DiDi™, and Lyft™, have fundamentally transformed lives and the way people travel in cities. The rising prevalence of these ride-hailing platforms raises an inevitable question, how to provide a reliable, trustworthy means of transportation while fulfilling most, if not every passenger's request in a highly dynamic environment with imb alance between supply (drivers) and demand (passengers) across time and space.

One possible approach to address this imbalance issue is to use a centralized planner that sends repositioning suggestions to idle cars (without a passenger) to relocate them to locations in anticipation of future demand shortage at the destinations. This can significantly improve the incomes of drivers as well as the experience of passengers.

Existing works like Braverman et al. (Braverman, A.; Dai, J. G.; Liu, X.; and Ying, L. 2019. Empty-car routing in ridesharing systems. Operations Research, 67(5): 1437-1452) formulated the repositioning task into a fluid-based optimization problem that can be solved by using linear programming (LP) which can dynamically capture the fluctuation of the complex system. But they assume that the system is already in the steady state, and that model parameters (including passenger arrival rate at each location) are known, both of which are unlikely in a practical system. Another related family of forward-looking methods is model predictive control (MPC), which leverages short-term demand forecasts based on historical data to obtain repositioning strategies by solving a planning problem. However, both the existing LP and MPC methods assume all the vehicles are fully controllable, which is obviously impossible in the real world.

In addition, due to the significant success of reinforcement learning (RL) in games and robotics systems, RL has also been applied to the problem of order dispatching and repositioning in ride-hailing systems. Jiao et al. (Jiao, Y.; Tang, X.; Qin, Z. T.; Li, S.; Zhang, F.; Zhu, H.; and Ye, J. 2020. A Deep Value-based Policy Search Approach for Real-world Vehicle Repositioning on Mobilityon-Demand Platforms. In NeurIPS Deep RL Workshop) learned a driver-perspective state-value function using spatiotemporal deep value networks and generated repositioning actions through value-based policy search. Other works proposed deep RL approaches, such as deep Qnetworks (DQN) and proximal policy optimization (PPO), for vehicle repositioning. All these approaches mentioned above do not explicitly consider the system dynamics, and these methods may be problematic when the controllable fraction of vehicles becomes larger. For example, crowding a large fleet of vehicles into a single location with high value causes undesirable imbalance.

According to embodiments, in light of the foregoing discussion regarding the existing approaches for vehicle repositioning, there is provided a system and method using an LP-based lookahead repositioning algorithm incorporating RL to maximize the completion rate of orders. The disclosed system and method may be used in real-time to provide repositioning recommendations to one or more vehicles of a vehicle pool, such as a ride hailing vehicle pool of a complex ride-hailing system.

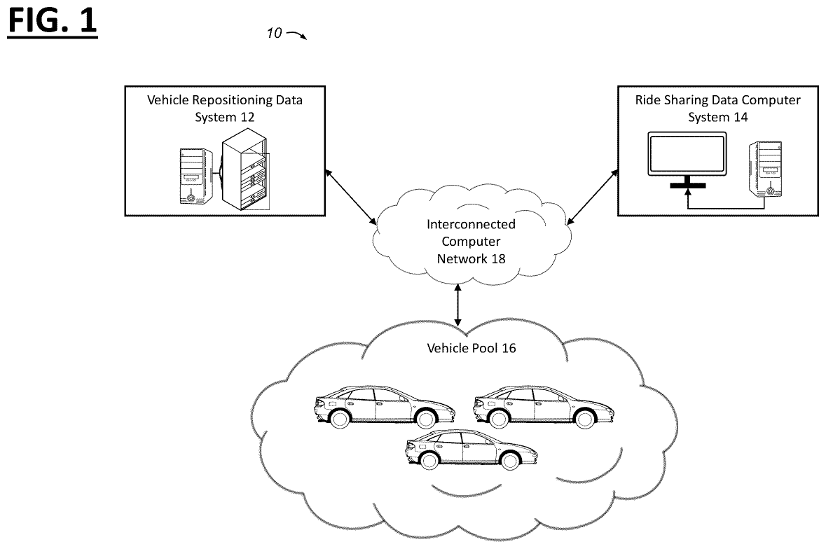

With reference to FIG. 1, there is shown a communications or operating system 10 that includes a vehicle repositioning data system 12, a ride sharing data computer system 14, a vehicle pool 16 having a plurality of vehicles, and an interconnected electronic data network 18 that is used to enable computer systems to communicate with one another, such as for communications between the vehicle repositioning data system 12, the ride sharing data computer system 14, and the vehicle pool 16. Each of the vehicles of the vehicle pool 16 includes an onboard vehicle computer system that is capable of transmitting vehicle information, such as global navigation satellite system (GNSS) data (e.g., global positioning system (GPS) data), to a remote computer system, such as the vehicle repositioning data system 12 and/or the ride sharing data computer system 14.

Each computer system discussed herein (including the vehicle repositioning data system 12, the ride sharing data computer system 14, and onboard vehicle computer systems) includes at least one processor and memory storing computer instructions accessible by the at least one processor. According to embodiments, the hardware of each computer system need not necessarily all be co-located, but may be distributed and, according to embodiments, cloud platforms or software services offered by cloud providers may be used.

Any one or more of the processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the computer-readable memory discussed herein may be implemented as any suitable type of non-transitory memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It will be appreciated that the computers or computing devices may include other memory, such as volatile RAM that is used by the electronic processor, and/or may include multiple electronic processors.

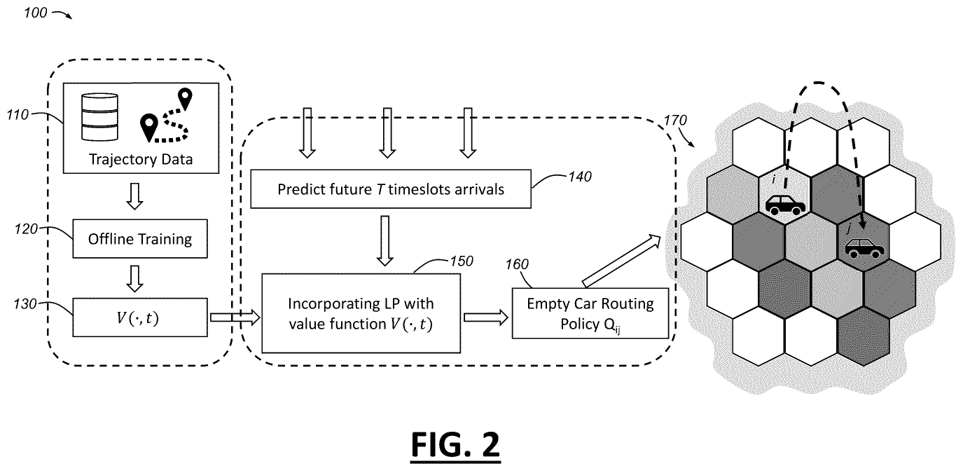

The vehicle repositioning data system 12 is configured to determine vehicle repositioning data using the method below, at least in some embodiments. According to embodiments, the vehicle repositioning data system 12 includes training a NN, such as the CNN discussed above, for purposes of implementing a passenger arrival rate estimation process; carrying out the passenger arrival estimation process to obtain estimated passenger arrival data for the vehicle pool 16; training (or pretraining) a value function to generate pretrained data based on historical data; determining a vehicle repositioning policy based on the pretrained value function and the estimated passenger arrival data; and determining vehicle repositioning data based on the vehicle repositioning policy. For example, with reference to FIG. 2, there is shown an exemplary diagrammatic depiction of a process 100 for determining vehicle repositioning data.

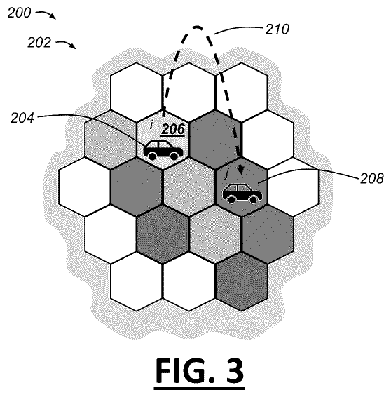

The process 100 of determining vehicle repositioning data includes obtaining training data (step 110), training a value function (step 120) based on the obtained training data to obtain a pretrained value function (step 130), determining estimated passenger arrival data for T future time steps or slots (step 140), incorporating LP (step 150) with the pretrained value function and the estimated passenger arrival data to determine a vehicle repositioning policy (step 160), and generating vehicle repositioning data according to the vehicle repositioning policy (step 170). The vehicle repositioning data indicates a repositioning location for a vehicle of the vehicle pool 16. Vehicle repositioning policy data is generated at step 160 and this vehicle repositioning policy data is data that represents the vehicle repositioning policy. The vehicle repositioning data is determined for a set of regions, such as the set of regions shown in FIG. 3 and discussed below.

With reference to FIG. 3, there is shown a diagrammatic representation of a spatial grid or map 200 having a set of regions 202 that are each illustrated as a hexagon in the illustrated embodiment of FIG. 3. FIG. 3 shows an indication of exemplary vehicle repositioning data that specifies moving empty vehicle 204 from region i (region 206 in FIG. 3) to region j (region 208 in FIG. 3), as indicated by arrow 210. In embodiments, the vehicle repositioning data specifies vehicle repositioning data for a plurality of vehicles, such as for two or more vehicles in the vehicle pool 16 or for each of the vehicles in the vehicle pool 16.

With reference back to FIG. 2, at each time slot, passenger arrival rates over the future T time slots are predicted using neural networks considering spatiotemporal correlation and, in some embodiments, the TM-CNN discussed herein. Then, the vehicle repositioning policy is generated by solving the LP with the predicted passenger arrival data and other estimated parameters. In embodiments, a centralized planner (or computer system) sends vehicle repositioning data to one or more drivers or vehicles, such as sending a repositioning recommendation to each idle driver. According to embodiments, a LP with lookahead time horizon T, which explicitly models the controllable fraction and also the non-stationarity of the system. According to embodiments, by incorporating a weighted pretrained value function which approximates the total profits of all drivers from time T+1 to the end of the horizon into the objective function, the method considers short-term system dynamics and long-term return simultaneously.

According to an embodiment, a closed queueing network is used to model the ride sharing system, such as that which is discussed in Braverman; Afeche et al. (Afeche, P.; Baron, 0.; Milner, J.; and Roet-Green, R. 2019. Pricing and prioritizing time-sensitive customers with heterogeneous demand rates. Operations Research, 67(4): 1184-1208). Let N be the number of vehicles and r be the number of regions in the set of regions. In this embodiment, each region is treated as a single-server station, where the idle vehicles are considered as jobs and assigning passengers' ride requests to idle vehicles corresponds to service completions at the station. The number of passenger arrival passengers in region i at time slot t is considered to be Poisson distributed with parameter Nλᵢ(t), i ∈ [r], where i ∈ [r] is shorthand for i ∈1, 2, . . . , n. In embodiments, traveling of the vehicles between regions is considered as infinite-server stations where vehicle travels are considered as jobs and the service time of a job corresponds to the travel time of a vehicle. For any i ∈ [r], j ∈ [r], let 1/μᵢⱼ(t) denote the average travel time from region i to region j at time slot t. Let Pᵢⱼ(t) denote the order destination distribution at time slot t, i.e., the probability of the event that a passenger travels to region j given that the passenger request originates from region i. Let q(t)={qᵢⱼ(t)} denote our repositioning policy at time slot t such that the idle vehicles at region i are repositioned to region j with probability qᵢⱼ(t). According to embodiments, the objective is to find an optimal solution q*(t) such that the least completion rate of the ride requests across all the regions can be maximized. This maximin objective is different from that used in (Braverman et al. 2019) at least since this maximin objective takes into consideration non-stationarity of the system and the controllable fraction, which has been found to be more robust in practice.

According to the definitions above, the model is described below in (1a)-(1f), which is an LP with multi-step lookahead as well as a learned or pretrained value function.

$${max}_{\overline{a} , \overline{f} , \overline{e}} ( min {\overline{a}}_{i} + {w}_{v} {\sum }_{j} V ( j , t + T ) {\sum }_{i} ( {\overline{e}}_{ij} + {\overline{f}}_{ij} ) ) \qquad ( 1 a )$$

$${\sum }_{u = 0}^{T - 1} {λ}_{i} ( t + u ) {P}_{ij} ( t + u ) {\overline{a}}_{i} = {\sum }_{u = 0}^{T - 1} {μ}_{ij} ( t + u ) {\overline{f}}_{ij} , ∀ i , j ∈ [ r ] \qquad ( 1 b )$$

$${\sum }_{u = 0}^{T - 1} {μ}_{ij} ( t + u ) {\overline{e}}_{ij} \leq η {\sum }_{k = 1}^{r} {\sum }_{u = 0}^{T - 1} {μ}_{ki} ( t + u ) {\overline{f}}_{ki} , ∀ i , j ∈ [ r ] , i \neq j \qquad ( 1 c )$$

$${\sum }_{u = 0}^{T - 1} {λ}_{i} ( t + u ) {\overline{a}}_{i} + {\sum }_{j = 1 , j \neq i}^{r} {\sum }_{u = 0}^{T - 1} {μ}_{ij} ( t + u ) {\overline{e}}_{ij} \leq {\sum }_{k = 1 , k \neq i}^{r} {\sum }_{u = 0}^{T - 1} {μ}_{ki} ( t + u ) {\overline{e}}_{ki} + {\sum }_{k = 1}^{r} {\sum }_{u = 0}^{T - 1} {μ}_{ki} ( t + u ) {\overline{f}}_{ki} , ∀ i ∈ [ r ] \qquad ( 1 d )$$

$${\sum }_{i = 1}^{r} {\sum }_{j = 1}^{r} ( {\overline{e}}_{ij} + {\overline{f}}_{ij} ) = 1 \qquad ( 1 e )$$

$${\overline{e}}_{ij} ∈ [ 0 , 1 ] , {\overline{f}}_{ij} ∈ [ 0 , 1 ] , {\overline{a}}_{i} ∈ [ 0 , 1 ] , ∀ i , j ∈ [ r ] \qquad ( 1 f )$$

Note that the parameters λᵢ(t), Pᵢⱼ(t), and μᵢⱼ(t) are time-varying. Hence, a T time slots lookahead method is provided that uses parameters averaged over the time slots t, t+1, . . . , t+T−1 in order to generate a vehicle repositioning policy that takes the future variation into account.

In the objective function (1a), a={āᵢ} in the first term is the order completion rate in region i. Hence, the first term maximizes the completion rate of the most severe region in short supply. The Max-min fairness is one of the classical objectives for traffic engineering or congestion control schemes, which ensures a fair distribution of the resources among competing flows and is most widely used in modern data center networks.

The second term of (1a) represents the expected discounted total returns from time t+T to the end of the time horizon considered. In this term, wᵥ is a weight used to strike a balance between the order completion rate over T time slots and the future rewards after T time slots. In particular, V(j,t) is the value function per vehicle in region j at time slot t, defined as

$$V ( j , t ) = {\sum }_{k = t}^{{T}_{end}} 𝔼 [ {γ}^{k - t} {R}_{t} \vert j , t ] \qquad ( 2 )$$

where T_{end} is the last time slot of the time horizon, (j, t) is viewed as the state for the value function, and y is the discount factor. R t is the reward that the vehicle obtains at time slot t. The reward of an order is assumed to be spread uniformly across the trip duration. e={ēᵢⱼ} and f={f̅ᵢⱼ} are the average number of empty vehicles and full vehicles driving from region i to region j, respectively.

In the constraint 1(b), the left-hand side Σᵤ₌₀^{T-1}λᵢ(t+u)Pᵢⱼ(t+u)āᵢ is the total inflow of occupied vehicles from region i to region j (infinite server station), which equals the right-hand side Σᵤ₌₀^{T-1}u ᵢ(t+u)f̅ᵢⱼ, the total outflow of occupied vehicles (vehicles with passengers).

The constraint (le) is a normalization for the sum of ēᵢⱼ and f̅ᵢⱼ, which is the total number of vehicles. The constraints (10 ensure that ēᵢⱼ and f̅ᵢⱼ are non-negative and āᵢ ∈ [0,1]. The constraints (1c) and (1d) are discussed below.

Controllable Fraction and Relaxed Constraints. The ideal situation is that every driver will accept the repositioning recommendations sent by the centralized planner. However, in practice, this is not true because drivers have their own personalities and preferences. It may also be difficult to reposition every idle driver due to a budget limit if each recommendation consumes an incentive bonus. The original formulation in (Braverman et al. 2019) does not consider this situation.

Therefore, in the formulation, a new parameter, controllable fraction η ∈ [0,1], is introduced and the controllable fraction η ∈[0,1] represents the probability that the driver accepts the repositioning recommendation. According to embodiments, it is assumed that if the driver does not accept the recommendation, the driver will stay where the driver is located (will not move). Hence, the following two balance equations are had:

$${\sum }_{u = 0}^{T - 1} {μ}_{ij} ( t + u ) {\overline{e}}_{ij} \leq {q}_{ij} η {\sum }_{k = 1}^{r} {\sum }_{u = 0}^{T - 1} {μ}_{ki} ( t + u ) {\overline{f}}_{ki} , ∀ i , j ∈ [ r ] , i \neq j \qquad ( 3 a )$$

$${\sum }_{u = 0}^{T - 1} {λ}_{i} ( t + u ) {\overline{a}}_{i} = {\sum }_{k = 1 , k \neq i}^{r} {\sum }_{u = 0}^{T - 1} {μ}_{ki} ( t + u ) {\overline{e}}_{ki} + ( 1 - η + η {q}_{ii} ) {\sum }_{k = 1}^{r} {\sum }_{u = 0}^{T - 1} {μ}_{ki} ( t + u ) {\overline{f}}_{ki} , ∀ i ∈ [ r ] \qquad ( 3 b )$$

where the term qᵢⱼη represents the probability of the event that an empty vehicle is repositioned from region i to region j, and the term (1−η+ηqᵢᵢ) represents the probability of the event that an empty vehicle stays in the current region i. Hence, the right-hand side of the constraint (3a) is the total inflow of empty vehicles to the way from region i to region j (by repositioning), which equals the left-hand side, i.e., the total outflow of empty vehicles. Since qᵢⱼ ≤1, the equality (3a) implies the inequality constraint (1c) in our formulation (1). As for (3b), the left-hand side is the total outflow of vehicles from region i and the right-hand side is the total inflow of vehicles to region i. Note that the original LP in (Braverman et al. 2019) was formulated with the assumption

that the Markov chain is already in the steady state. However, it takes time for the system to converge to the steady-state. In practice, when the environment changes fast, the system may rarely be in the steady state. Therefore, in order to capture this non-stationarity property, the equality in (3b) is changed to an inequality as follows:

$${\sum }_{u = 0}^{T - 1} {λ}_{i} ( t + u ) {\overline{a}}_{i} \leq {\sum }_{k = 1 , k \neq i}^{r} {\sum }_{u = 0}^{T - 1} {μ}_{ki} ( t + u ) {\overline{e}}_{ki} + ( 1 - η + η {q}_{ii} ) {\sum }_{k = 1}^{r} {\sum }_{u = 0}^{T - 1} {μ}_{ki} ( t + u ) {\overline{f}}_{ki} , ∀ i ∈ [ r ] \qquad ( 4 a )$$

which means that the rate of inflow into region i is allowed to be larger than the rate of outflow from the region. This may happen when the system is not in the steady state. Since the right-hand side of (3b) is non-increasing in η, the righthand side may be larger especially when η is small. This idea explains the phenomenon we observed in the simulation that the proposed algorithm has a good performance even if the controllable fraction η is small. Then from (3a), (4a), and the relation Σⱼ₌₁^{r}qᵢⱼ=1, (1d) is obtained.

Exemplary Algorithms. Based on the above-discussed LP formulation (1a)-(1f) Algorithm 1 is provided. Note that qᵢⱼ *(t) in (6) is not guaranteed to be nonnegative. Therefore, Line 8-Line 12 is used to make q*(t) a valid repositioning policy (probability matrix). Before solving the LP, an estimate of the value function V is obtained; according to embodiments, this value function V may be trained offline by using reinforcement learning (RL), such as, for example, tabular TD learning. According to the present embodiment, a discounting technique, such as the one used in (Tang et al. 2019), is used and the value function V is trained offline using historical data, which may be generated by a simulator, for example, or retrieved from a remote data repository. The update rule for the value in region i at time t in the training process is defined as:

$${V}^{k + 1} ( i , t ) ← {V}^{k} ( i , t ) + α [ \frac{{R}_{t} ( {γ}^{{L}_{t}} - 1 )}{{L}_{t} ( γ - 1 )} + {γ}^{{L}_{t}} {V}^{k} ( {D}_{t} , t + {L}_{t} ) - {V}^{k} ( i , t ) ]$$

where (Rₜ, Lₜ, Dₜ) is a completed order sampled from historical data with starting region i and starting time slot t. Rᵢ is the reward of the order, Lᵢ is the trip duration, and Dᵢ is the destination.

Algorithm 1: LP and Prediction based Lookahead

```
  1 Input: N, η, wᵥ, μᵢⱼ(s), Pᵢⱼ(s),
    s ∈ {t, t + 1, ..., t + T − 1}, λᵢ(s),
    s ∈ {t − M, ..., t − 1}, V(j, t + T), ∀i, j ∈ [r]
  2 Output: q*(t) ;
  3 Prediction arrival rates λᵢ(s), s ∈ {t, ..., t + T − 1} ;
  4 { λᵢ(s) } ← SPLIT({λᵢ (s)}) ;
  5 Solve the LP problem (1), obtain ē*, f̅*, ā*;
  6 Compute q*(t) for i, j ∈ [r]:
  7  ${q}_{ij}^{*} ( t ) = \frac{{\sum }_{u = 0}^{T - 1} {μ}_{ij} ( t + u ) {\overline{e}}_{ij}^{*}}{η {\sum }_{k = 1}^{r} {\sum }_{u = 0}^{T - 1} {μ}_{ki} ( t + u ) {\overline{f}}_{ki}^{*}} , if i \neq j \qquad ( 5 )$
  ${q}_{ii}^{*} ( t ) = 1 - {\sum }_{j \neq i} {q}_{ij}^{*} ( t ) , i ∈ [ r ] \qquad ( 6 )$
  for i do
  8 | if q*ᵢᵢ (t) < 0 then
  9 | | q*ᵢᵢ (t) ← 0;
10 | | sum ← Σⱼ₌₁^{r} q*ᵢⱼ (t);
11 | | for j do
12 | | | ${q}_{ij}^{*} ( t ) ← \frac{{q}_{ij}^{*} ( t )}{sum} ; / / normalization$
```

The parameters that are used to train the value function V(j, s) are shown below, where N(j , s) is the number of times that the training process has visited the state (j, s).

| Parameter | Value |
|---|---|
| Discount factor γ | 0.95 |
| Batch size | 20000 |
| Learning rate α | $\frac{1}{N ( j , s )}$ |
| Time horizon T_{end} | 144 |

According to embodiments, the lookahead length or time horizon T may be set based on analyzing the lookahead length in regard to noise in the estimation. In one implementation and according to one embodiment, it was found that when the lookahead length increases, the completion rate tends to increase first, because of considering the system information of near future, and then decreases, because of the increasing noise in the estimation when the planning horizon is too long. In one exemplary implementation and according to one embodiment, a lookahead length of 30 minutes was determined as being optimal.

After training the value function offline, at each time slot t, the future passenger arrival rates λᵢ(s), s ∈ {t,t+1, . . . , t+T−1} are predicted. Next, the passenger arrival rates {λᵢ(s)} of each region may be split to their neighbors according to Algorithm 2, according to embodiments. Then, the LP is solved to obtain the optimal solution q*(t) (repositioning matrix) for the T steps given the approximated value function. Finally, the centralized planner samples a repositioning decision for each idle driver based on q*(t) and sends the recommendation to the driver. This process may be repeated until the end of the day or for some other predetermined time frame.

Algorithm 2: SPLIT

```
  1 Input: { λ } ;
  2 Output: { \tilde{λ} } ;
  3 Initial { \tilde{λ} } ← 0, α_{c}, αₙ;
  4 for λᵢ in { λ } do
  5 | l ← the set of neighbors of i including i;
  6 | for region j in l do
  7 | | if j=i then
  8 | | | ${\tilde{λ}}_{j} ← {\tilde{λ}}_{j} + {λ}_{i} \cdot \frac{{α}_{c}}{( length ( l ) - 1 ) {α}_{n} + {α}_{c}}$
  9 | | else
10 | | | ${\tilde{λ}}_{j} ← {\tilde{λ}}_{j} + {λ}_{i} \cdot \frac{{α}_{n}}{( length ( l ) - 1 ) {α}_{n} + {α}_{c}}$
```

Prediction of Passenger Arrival Rates. It is noted that, according to at least some embodiments, the proposed algorithms are lookahead policies, which use the estimation of future λᵢ(s), Pᵢⱼ(s), and μᵢⱼ(s), s ∈ {t,t+1, . . . , t+T−1}. In embodiments, the inverse of travel time μᵢⱼ(s) and the destination distribution Pᵢⱼ(s) are estimated by using the average of the historical data. Since the passenger arrival rates may vary significantly during one day and also fluctuate across different days, a robust method to estimate passenger arrival rates (or other passenger arrival data) before using such estimated passenger arrival data as input for the LP. In this section, a neural network (NN) based prediction method is proposed for estimating real-time passenger arrival rates.

It has been discovered that there is a common trend for the number of rides requested during a day; for example, the number of orders have peaks during rush hours for each day. Hence, a detrending method, such as the one in (Li, Z.; Li, Y.; and Li, L. 2014. A comparison of detrending models and multi-regime models for traffic flow prediction. IEEE Intelligent Transportation Systems Magazine, 6(4): 34-44), is used to first reduce this common trend before doing online prediction. The first step of the detrending method is to determine a trend by taking a simple average of the historical data over multiple days. Then, the residual time series can be obtained by subtracting the intra-day trend. Next, prediction methods can be used to predict the future residual passenger arrival rates. At last, these residual passenger arrival rates will be added up with the trend at that time to obtain the final predicted future passenger arrival rates.

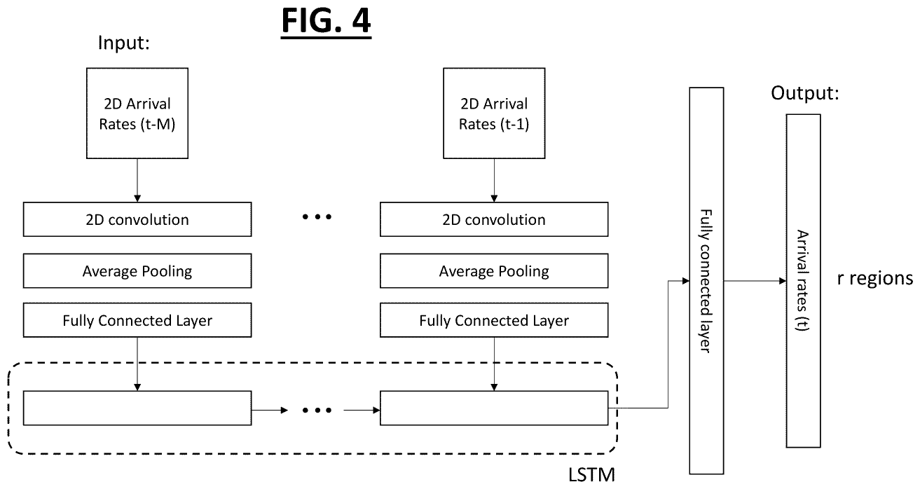

In order to utilize the spatiotemporal correlation of the passenger arrival rates, a long short-term memory convolutional neural network (LSTM-CNN) is proposed and, according to embodiments, the LSTM-CNN is combined with a detrending method. The structure of LSTM-CNN is shown in FIG. 4. The LSTM part captures the temporal correlation and the CNN captures the spatial correlation of the passenger arrival rates. The details of an exemplary network structure and parameters is shown below. The network and training parameters for LSTM-CNN are shown below. Pytorch may be used to implement the LSTM-CNN and its training.

| Parameter | Value |
|---|---|
| Out features of convolutional layers | 4 |
| Kernel size of convolutional layers | (3, 3) |
| Stride of convolutional layers | 1 |
| Padding of convolutional layers | 1 |
| Output size of average pooling layers | (4, 4) |
| Size of fully connected layers | 64 × 8 |
| Input features of LSTM | 8 |
| Hidden features of LSTM | 8 |
| Size of the last fully connected layer | 8 × 20 |
| Batch size | 20 |
| Optimizer | Adam |
| Learning rate | 0.001 |
| Weight decay regularization | 0.005 |

Splitting Passenger arrivals. A splitting passenger arrivals method may be used at Line 4 in Algorithm 1, according to embodiments. An embodiment of the splitting passenger arrivals method is defined in Algorithm 2. The reason is that in practice drivers can accept order requests from neighbor grids. In previous works including LP-based or RL-based works, drivers are assumed to take orders only from their current grids which is not true in practice in which orders are dispatched based on a predefined broadcasting distance between customers and drivers. This becomes an issue and cannot be ignored in a large-scale system. For example, for some grids which are close to the hot areas, although these grids may not have passenger arrivals, they indeed have virtual passenger arrivals because they are allowed to accept orders from their neighbors. The passenger arrival rate of a grid is uniformly split into its neighbors after predicting the demands online. Note that Algorithm 2 is a weighted splitting algorithm, α_{c}, αₙ are designed based on the platform order dispatching policy and the grid radius.

Reposition Cost. According to embodiments and implementations, if the LP problem has multiple optimal solutions, it may be desirable to choose the one which repositions to closer areas since the drivers would like to reduce the travel (fuel) cost or consider the case where each completed repositioning consumes a bit of budget as an incentive bonus. By further adding a small penalty to the objective function while keeping the objective function linear, a new LP is obtained whose solution will have a lower travel cost while maintaining a similar order completion rate. The new objective function is designed as follows:

$$( 1 a ) - {w}_{tr} {\sum }_{i \neq j} {\overline{e}}_{ij} {d}_{ij}$$

where dᵢⱼ is the normalized distance (dᵢⱼ≤1) between region i and region j, and wₜᵣ is a parameter that can be adjusted to balance these objectives.

The above-described formulations and discussions under the “Exemplary Algorithms”, “Prediction of Passenger arrival Rates”, “Splitting Passenger arrivals”, and “Reposition Cost” describe details of the disclosed systems and methods, according to embodiments, and are exemplary in nature.

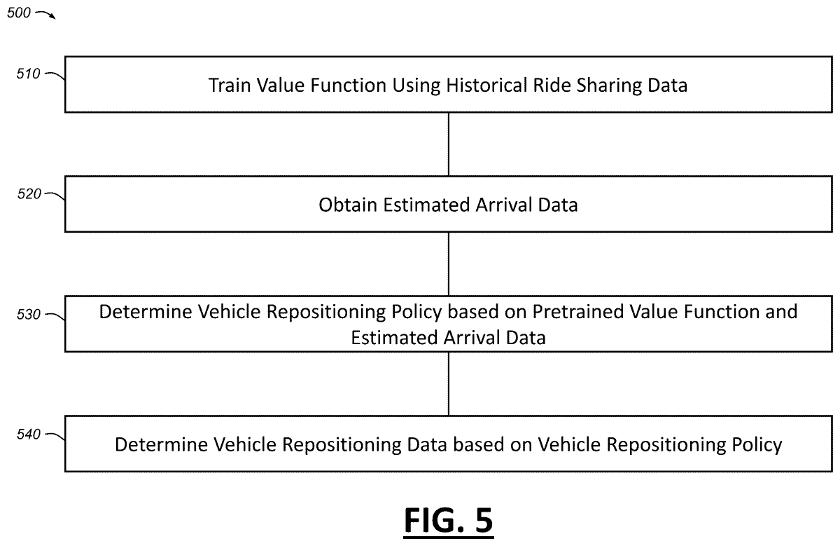

With reference to FIG. 5, there is shown a method 500 of determining vehicle repositioning data for a vehicle pool. In embodiments, the method 500 is performed by the vehicle repositioning data system 12. Although the method 500 is described below as carrying out steps 510-540 in a particular order, the steps 510-540 may be carried out in any technically-feasible order, as will be appreciated by those skilled in the art; for example, in embodiments, step 520 may be performed prior to step 510 or concurrently with step 510.

The method 500 begins with step 510, wherein a value function is pretrained using historical ride sharing data. In embodiments, the historical ride sharing data is data indicating trajectory information for one or more vehicles (such as one or more vehicles of the vehicle pool) and/or order completion rate information for a set of regions and, in embodiments, may include more precise data, such as order completion rates for a set of sub-regions for each region of the set of regions. The historical ride sharing data may be obtained from the ride sharing data computer system 14, or other remote data repository. As discussed above in connection with step 110, the training data or historical ride sharing data may be trajectory data, such as GNSS data indicating vehicle locations over time. Furthermore, in some embodiments, order information pertaining to ride sharing or ride hailing customer orders may be used as well for training. In some embodiments, the training the value function includes performing reinforcement learning (RL) and, in particular, temporal difference (TD) learning, such as the tabular TD learning discussed above. In embodiments, pretraining of the value function is performed and this is carried out offline; further, this pretraining may be referred to as offline training or offline pretraining. In embodiments, the training the value function (step 510) may be performed periodically according to a predetermined time interval. The method 500 continues to step 520.

In step 520, estimated passenger arrival data is obtained. In embodiments, the estimated passenger arrival data is obtained by generating the estimated passenger arrival data using a temporal memory convolutional neural network (TM-CNN) having temporal memory (TM) and a convolutional neural network (CNN) having at least two CNN layers, such as the long short-term memory LSTM-CNN discussed above. Thus, according to embodiments, the TM-CNN is an LSTM-CNN; however, in other embodiments, gated recurrent units (GRUs) may be used as the TM. In some embodiments, the TM-CNN is configured to receive, as input, historical passenger arrival data. In embodiments, the historical passenger arrival data is two-dimensional (2D) passenger arrival data representing passenger arrival information for locations within two-dimensional space, and the historical passenger arrival data may be generated by a simulator and/or obtained from a remote data repository. The method 500 continues to step 530.

In step 530, a vehicle repositioning policy is determined based on the pretrained value function and the estimated passenger arrival data. In embodiments, the vehicle repositioning policy is determined periodically for a predetermined time period and using estimated passenger arrival data for the predetermined time period. In at least some embodiments, the vehicle repositioning policy is determined by solving a linear programming (LP) problem discussed above, which may be formulated as a lookahead model in that future estimated passenger arrival data is considered as a part of the LP problem, as discussed above. The method 500 continues to step 540.

In step 540, vehicle repositioning data is determined for a vehicle pool based on the vehicle repositioning policy. In embodiments, the vehicle repositioning data is for a plurality of vehicles of the vehicle pool, such as a plurality of empty vehicles in the vehicle pool. In embodiments, the vehicles of the vehicle pool report location information (e.g., GNSS data) to the vehicle repositioning data system 12, which then uses the location and order status information of the vehicle (e.g., the vehicle is empty, the vehicle is on the way to pick up a passenger/customer), in conjunction with the determined vehicle repositioning policy to determine the vehicle repositioning data, which may indicate recommended repositioning locations. In embodiments, the vehicle repositioning data is for each empty vehicle of the vehicle pool. The method 500 ends.

Simulation & Evaluation. Extensive experiments on a small-scale simulator using real world datasets show that the disclosed method achieves considerable improvements over other baseline methods and is robust to prediction errors. The disclosed method was further adapted and evaluated on a more complex and realistic simulation platform similar to that for the KDD Cup 2020 RL track competition, and simulation results demonstrate that the disclosed method achieves state-of-art results on improving the completion rate of the orders in the system.

Simulation Results. In this section, several extensive experiments that were designed to verify the performance and robustness of our algorithm are discussed. First, the simulation platform and settings are introduced.

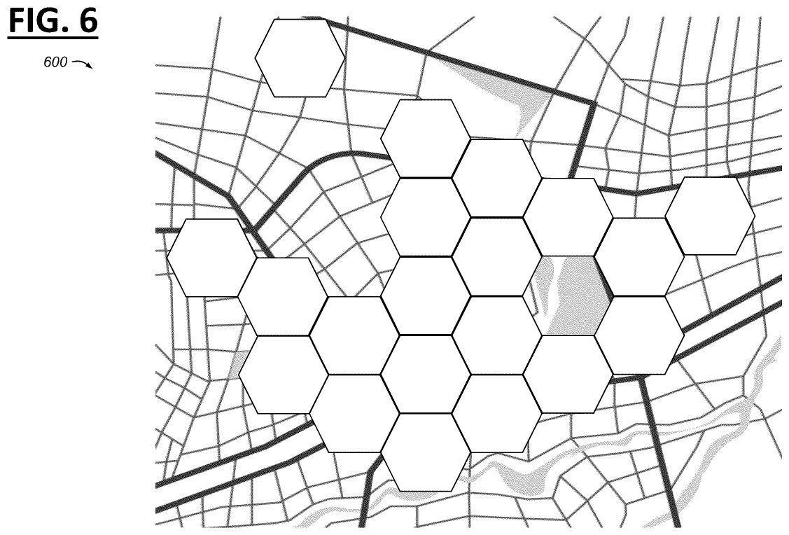

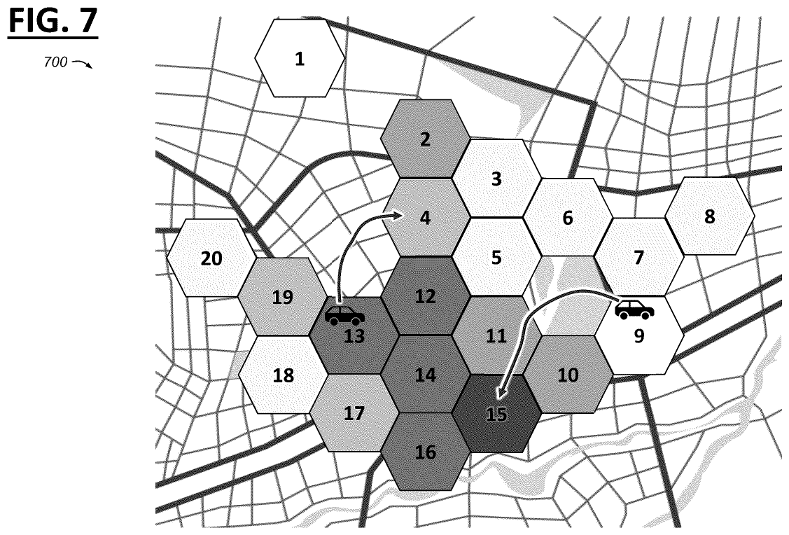

Simulation Platform. The simulations were conducted on a platform built using the public real-world dataset which was also used by the KDD Cup 2020 RL track competition. The platform includes r=20 hexagon grids with radius about 600 m, which are chosen from the hot regions (heavy traffic regimes) of the dataset. The distributions of the grids are shown in FIG. 6, which is an illustration of the grid map 600. FIG. 7 shows an illustration of vehicle repositioning data 700 specifying specific vehicle repositioning recommendations for two vehicles; in FIG. 7, the arrow denotes the reposition direction and the shading represents different level of demand of the corresponding grid, with darker denoting higher demand. The orders are generated by sampling from the dataset. The passenger arrival rates are synthetic and assumed to follow Poisson distributions with time-varying parameters, which change every 10 minutes. The arrival rates of some of the grids are defined to be the average of those of their neighboring grids in order to generate some spatial correlation. The platform dispatches orders to the idle drivers and repositions the idle drivers every minute. During the simulation, the dispatching algorithm is fixed and unknown to the reposition algorithm. Orders can be dispatched to drivers within a fixed broadcasting distance, e.g., 1.2 km in one of the simulations performed. Then α_{c}=1, αₙ=0.5 were chosen in Algorithm 2. The drivers will stay where they are if they do not get any order and reposition tasks. The time interval is from 1:00 p.m. to 7:59 p.m. and the number of drivers (vehicles) is fixed during this time period. The number of drivers is 300, and the controllable fraction is assumed to be 0.2 unless otherwise specified. Drivers during repositioning can accept orders in the destination grid beforehand, and a driver who completes repositioning needs to wait for 5 minutes to accept a new reposition recommendation if no orders are assigned to the driver. These setting have been made after discussing with researchers from a ride-hailing company.

In Algorithm 1, 10 minutes is set as one time slot, according to the simulation run. The lookahead time T is set to be 2 time slots (20 minutes) unless otherwise specified, in the simulated embodiment. The repositioning routing matrix q*(t) was recalculated at the beginning of every time slot; in embodiments, the vehicle repositioning policy (and vehicle repositioning policy data) is recalculated/re-determined periodically according to a predetermined time interval or according to a predetermined schedule. For the travel time 1/ηᵢₜ(t) and destination distribution Pᵢⱼ(t), the average of the historical data was used. For the passenger arrival rate λᵢ(t) , previous M=6 time slots were used for the online prediction. The weight wᵥ was set to be 0.3 unless otherwise specified. The results of each experiment are averaged over 30 trials. It should be appreciated that the values referred to above were for purposes of evaluating an embodiment of the present disclosure and that other values may be used, according to embodiments.

Baseline Algorithms for Simulation. In the simulations, the disclosed repositioning algorithms were compared with the following policies: (i) Stay: Stay policy is simply no repositioning; (ii) Expert: A human expert policy extracted from the historical idle driver transition data which captures the collective intelligence; (iii) Neighbors: This is a heuristic policy which repositions the idle drivers to one of set of its neighbors and itself uniformly at random; (iv) LP: This policy directly uses the solution of LP without value function as the reposition policies. It uses the ground truth of expected arrival rates or predicted values of arrival rates (LP-P); (v) LP-S: This policy uses the solution of LP model of (Braverman et al. 2019) under a stationary system assumption. It uses the ground truth of expected arrival rates; and (vi) Value Based-R: This stochastic policy will sample the reposition destination with probability proportional to the value of neighbors' grids. (i.e., the method in (Jiao et al. 2020).).

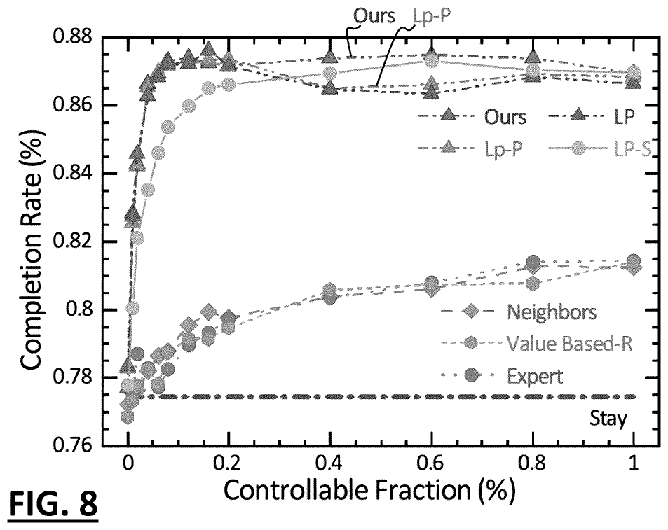

Controllable Fraction. In this subsection, the influence of controllable fractions on the total order completion rates is investigated. FIG. 8 shows completion rate when varying the controllable fractions, and illustrates that the disclosed algorithm outperforms the other policies under different controllable fractions. For example, for controllable fraction η=0.2, the completion rate of our algorithm increases by 9.3% compared with other non-LP based policies, and 12.6% compared with no repositioning (Stay). Also, the order completion rate increases when the controllable fraction increases until “saturation” points. The saturation point of the disclosed algorithm is only 0.12 and the disclosed algorithm already achieves a completion rate as high as 0.873 by controlling only 10% vehicles which is possible to be implemented in real ride-hailing platform. However, the LP without considering non-stationary system and controllable fraction rate needs at least control 60% vehicle to achieve similar completion rate. In addition, by including value function and prediction can further boost the performance as shown in FIG. 8.

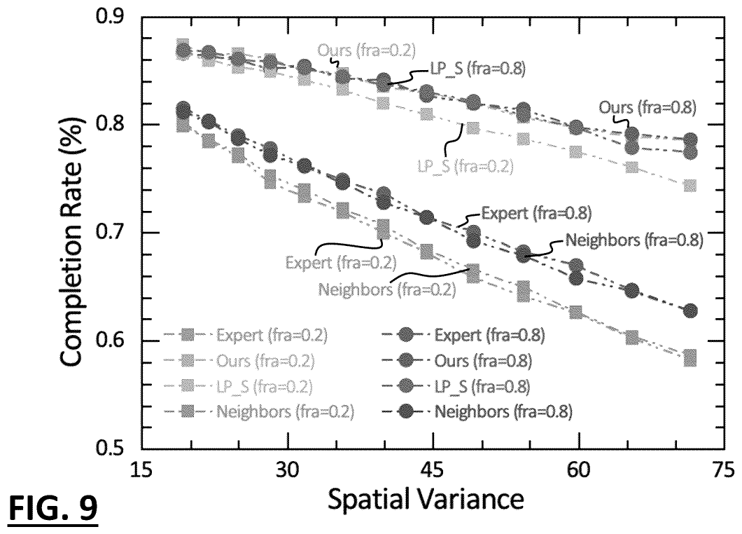

Spatial Heterogeneity. In this subsection, the impact of spatial heterogeneity of the arrival rates on the performance of the repositioning algorithms is studied. Some arrivals were manually moved from the 10 grids with lower arrival rates to the other 10 grids to increase spatial heterogeneity. The variance of the arrival rates of the 20 grids was used to quantify the spatial heterogeneity. FIG. 9 shows that as the spatial heterogeneity increases, the completion rate decreases for all algorithms with different speeds. For example, for controllable fraction η=0.2 and spatial variance 70, while Neighbors policy only has a completion rate of 0.587, the disclosed algorithm can still achieve a completion rate of 0.786. The disclosed algorithm performs better under two different controllable fraction rates than LP-S which uses true arrival rates to obtain a solution.

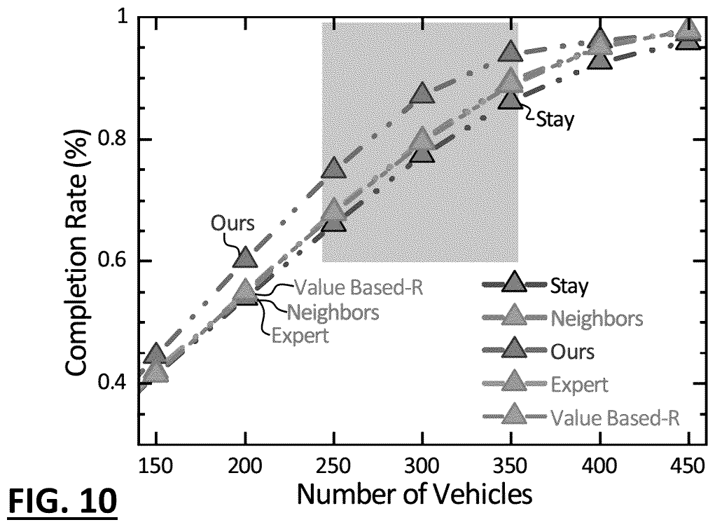

Number of Vehicles. FIG. 10 shows the influence of the total number of vehicles on the performance. Not surprisingly, the completion rate increases when the number of vehicles increases for all the algorithms. In fact, the number of vehicles represents the supply-demand gap of the system. There is obviously a supply-demand interval (250-350 vehicles) where repositioning will have a significant gain. When the number of vehicles is large, i.e., supply is enough, there is no need to do repositioning and all the reposition algorithm can have been reasonably good performance. On the contrary, when the number of vehicles is small, i.e., supply is rare, there is also no need to do repositioning since roughly all the vehicles are busy all time and there are no idle drivers in the system. This indicates that there exists a traffic regime in which the reposition algorithms can play a significant role.

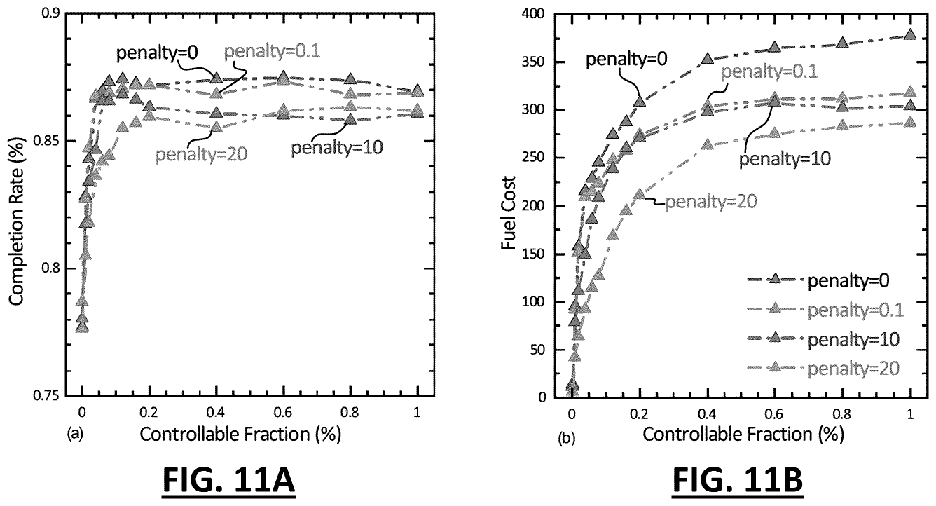

Reposition Cost. FIGS. 11A-B compares the travel (fuel) cost and the completion rate among different objective functions. Results show that by selecting a small penalty (wₜᵣ) defined in (7), the travel cost can be reduced by up to 23.6% while maintaining a similar completion rate.

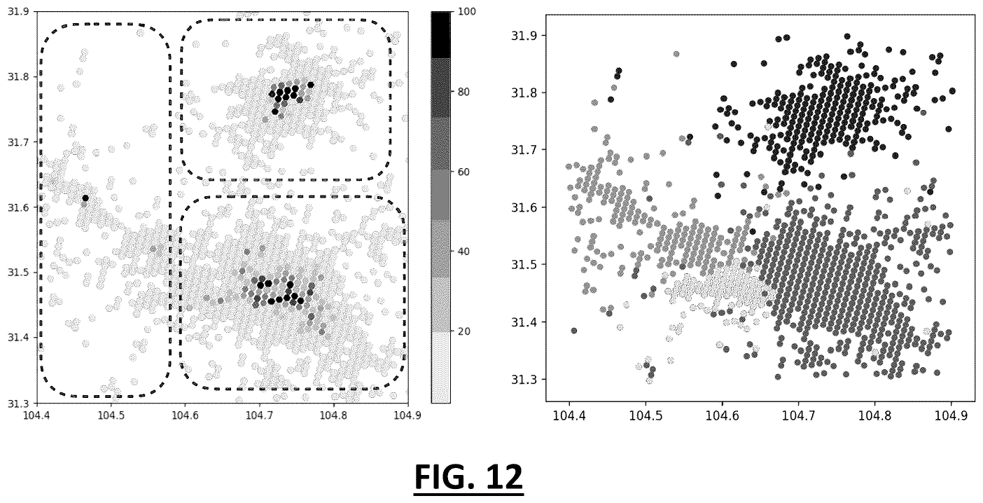

Simulation on a More Complex and Realistic Platform. To further validate the practicality of the disclosed algorithm, the disclosed method was modified and evaluated on a more realistic and complex simulation platform similar to the one for KDD Cup 2020 RL track competition. The simulator contains 1745 grids, which makes it more challenging to solve the LP problem. Drivers are allowed to take orders even during repositioning. Since all the features bring new difficulties for solving the LP, the LP was modified according to the following changes: (i) since a city usually has several centers (downtown and suburb), the Louvain method (Blondel et al. 2008) is applied for community detection on the map used in the platform; and (ii) the repositioning distance is restricted to 2 hops, which significantly reduces the number of variables in the LP problem. As shown in FIG. 12, the graph on the righthand side is the detecting result which illustrates that there are four main areas in the city, which is consistent with the heat map on the left-hand side. Then, the city is divided into three parts (in the box) and model each part with a separate LP. Then, the parallel LP problems and the computation issue can be solved.

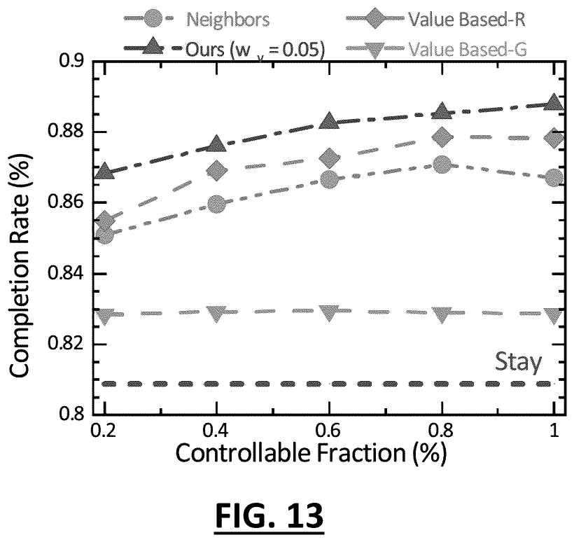

Simulation Results. As shown in FIG. 13, the disclosed method still outperforms other algorithms on the complex simulation environment. In the simulation, the RL method from (Tang et al.. 2019) was adopted to train the value function. Compared with the value function based method Value Based-R (Tang et al.. 2019), the disclosed algorithm increases the completion rate by 1 percent. The baseline Value Based-G refers to the greedy repositioning policy that routes empty cars to the region with the highest value. It is to be understood that the foregoing description is of one or more embodiments of the

invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of determining vehicle repositioning data for a vehicle pool, the method comprising:
training a value function using historical ride sharing data;
obtaining estimated passenger arrival data, wherein the estimated passenger arrival data is obtained by generating the estimated passenger arrival data using a temporal memory convolutional neural network (TM-CNN);
determining a vehicle repositioning policy based on the trained value function and the estimated passenger arrival data; and
determining vehicle repositioning data for a vehicle pool based on the vehicle repositioning policy.

2. The method of claim 1, wherein the historical ride sharing data includes trajectory data from the vehicle pool.

3. The method of claim 1, wherein the TM-CNN includes temporal memory (TM) and a convolutional neural network, and wherein the TM includes at least one of long short-term memory and a gated recurrent unit (GRU).

4. The method of claim 3, wherein the CNN includes an encoding layer and a decoding layer, and wherein the TM is interposed in an embedding layer between the encoding layer and the decoding layer.

5. The method of claim 4, wherein input into the TM-CNN includes two-dimensional (2D) passenger arrival data representing passenger arrival information for locations within two-dimensional space and for a given time or time period.

6. The method of claim 1, wherein the vehicle repositioning policy is determined periodically according to a predetermined time interval.

7. The method of claim 1, wherein the vehicle repositioning data is for a plurality of vehicles of the vehicle pool.

8. The method of claim 1, wherein the vehicle repositioning policy is determined using an optimization lookahead method that takes into consideration the estimated passenger arrival data.

9. The method of claim 8, wherein the optimization lookahead method uses linear programming (LP).

10. The method of claim 1, wherein a controllable fraction is determined based on the historical ride sharing data or other historical ride sharing data, and wherein the controllable fraction is used for determining the vehicle repositioning policy.

11. A vehicle repositioning system, comprising:
at least one processor;
memory storing computer instructions;
wherein the vehicle repositioning system is configured to use the at least one processor to execute the computer instructions so that when the computer instructions are executed by the at least one processor, the vehicle repositioning system:
train a value function using historical ride sharing data;
obtain estimated passenger arrival data, wherein the estimated passenger arrival data is obtained by generating the estimated passenger arrival data using a temporal memory convolutional neural network (TM-CNN);
determine a vehicle repositioning policy based on the trained value function and the estimated passenger arrival data; and
determine vehicle repositioning data for a vehicle pool based on the vehicle repositioning policy.

12. The vehicle repositioning system of claim 11, wherein the historical ride sharing data includes trajectory data from the vehicle pool.

13. The vehicle repositioning system of claim 11, wherein the TM-CNN includes temporal memory (TM) and a convolutional neural network, and wherein the TM includes at least one of long short-term memory and a gated recurrent unit (GRU).

14. The vehicle repositioning system of claim 13, wherein the CNN includes an encoding layer and a decoding layer, and wherein the TM is interposed in an embedding layer between the encoding layer and the decoding layer.

15. The vehicle repositioning system of claim 14, wherein input into the TM-CNN includes two-dimensional (2D) passenger arrival data representing passenger arrival information for locations within two-dimensional space and for a given time or time period.

16. The vehicle repositioning system of claim 11, wherein the vehicle repositioning policy is determined periodically according to a predetermined time interval.

17. The vehicle repositioning system of claim 11, wherein the vehicle repositioning data is for a plurality of vehicles of the vehicle pool.

18. The vehicle repositioning system of claim 11, wherein the vehicle repositioning policy is determined using an optimization lookahead method that takes into consideration the estimated passenger arrival data.

19. The vehicle repositioning system of claim 18, wherein the optimization lookahead method uses linear programming (LP).

20. The vehicle repositioning system of claim 11, wherein a controllable fraction is determined based on the historical ride sharing data or other historical ride sharing data, and wherein the controllable fraction is used for determining the vehicle repositioning policy.
